(19) United States
(12) Patent Application Publication
(10) Pub. No.: US 2024/0326416 A1
(43) Pub. Date: Oct. 3, 2024

(54) LIQUID EJECTION APPARATUS AND PRINT HEAD

(71) Applicant: SEIKO EPSON CORPORATION, Tokyo (JP)

(72) Inventors: Koichi KASHU, Shiojiri (JP); Toru MATSUYAMA, Matsumoto (JP)

(21) Appl. No.: 18/621,195

(22) Filed: Mar. 29, 2024

(30) Foreign Application Priority Data
Mar. 31, 2023 (JP) 2023-058274

(51) Int. Cl. B41J 2/045

(52) U.S. Cl. CPC B41J 2/04581; B41J 2/04541; B41J 2/0455; B41J 2/04568

(57) ABSTRACT

A drive signal output circuit that outputs a drive signal for driving a piezoelectric element includes an integrated circuit that outputs a first control signal, a first switching element operated by the first control signal, and a wiring board on which the integrated circuit and the first switching element are provided, wherein the first switching element includes a first transistor chip, a first terminal, a second terminal, and a third terminal all of which are electrically coupled to the first transistor chip, and a first mold member covering the first transistor chip, wherein a conduction state between the second terminal and the third terminal is controlled according to the first control signal input to the first terminal, and wherein the first terminal, the second terminal, and the third terminal are provided only at positions overlapping with the first mold member along a direction normal to the wiring board.

The present application is based on, and claims priority from JP Application Serial Number 2023-058274, filed Mar. 31, 2023, the disclosure of which is hereby incorporated by reference herein in its entirety.

### BACKGROUND

### 1. Technical Field

The present disclosure relates to a liquid ejection apparatus and a print head.

### 2. Related Art

There is known a liquid ejection apparatus that includes a piezoelectric element such as a piezo element to form an image or a document on a medium by ejecting a liquid. A piezoelectric element is provided to correspond to each of the plurality of nozzles, and each piezoelectric element operates according to a drive signal to eject ink from the corresponding nozzle. Such a piezoelectric element is electrically a capacitive load, such as a capacitor, and therefore, it is necessary to supply a sufficient current to operate the piezoelectric element. Therefore, the liquid ejection apparatus includes a drive signal output circuit that can supply a sufficient current to drive the piezoelectric element.

For example, JP-A-2022-117050 discloses a liquid ejection apparatus including a drive circuit that outputs a drive signal for driving a piezoelectric element.

However, the liquid ejection apparatus described in JP-A-2022-117050 is not sufficient in terms of protecting the drive circuit that outputs the drive signal from the ejected liquid, and there is room for improvement.

### SUMMARY

According to an aspect of the present disclosure, a liquid ejection apparatus includes an ejection head that ejects a liquid according to driving of a piezoelectric element, a drive signal output circuit that outputs a drive signal for driving the piezoelectric element, and a base drive signal output circuit that outputs a base drive signal that is a base of the drive signal, wherein the drive signal output circuit includes an integrated circuit that receives the base drive signal and outputs a first control signal, a first switching element operated by the first control signal, and a wiring board on which the integrated circuit and the first switching element are provided, wherein the first switching element includes a first transistor chip, a first terminal, a second terminal, and a third terminal all of which are electrically coupled to the first transistor chip, and a first mold member covering the first transistor chip, wherein a conduction state between the second terminal and the third terminal is controlled according to the first control signal input to the first terminal, and wherein the first terminal, the second terminal, and the third terminal are provided only at positions overlapping with the first mold member along a direction normal to the wiring board.

According to another aspect of the present disclosure, a print head includes an ejection head that ejects a liquid according to driving of a piezoelectric element, and a drive signal output circuit that outputs a drive signal for driving the piezoelectric element, wherein the drive signal output circuit includes an integrated circuit that receives a base drive signal that is a base of the piezoelectric element and outputs a first control signal, a first switching element operated by the first control signal, and a wiring board on which the integrated circuit and the first switching element are provided, wherein the first switching element includes a first transistor chip, a first terminal, a second terminal, and a third terminal all of which are electrically coupled to the first transistor chip, and a first mold member covering the first transistor chip, wherein a conduction state between the second terminal and the third terminal is controlled according to the first control signal input to the first terminal, and wherein the first terminal, the second terminal, and the third terminal are provided only at positions overlapping with the first mold member along a direction normal to the wiring board.

### BRIEF DESCRIPTION OF THE DRAWINGS

FIG. 1 is a diagram showing a schematic configuration of a liquid ejection apparatus.

FIG. 2 is a diagram showing the functional configuration of the liquid ejection apparatus.

FIG. 3 is a diagram showing a schematic structure of one of the ejection units.

FIG. 4 is a diagram showing the configuration of a drive signal output circuit.

FIG. 5 is a diagram showing an example of the structure of a switching element.

FIG. 6 is a diagram showing an example of the structure of a switching element.

FIG. 7 is a diagram showing an example of the structure of a switching element.

FIG. 8 is a diagram showing an example of the structure of a switching element.

FIG. 9 is a diagram for describing the structure of a drive signal output circuit.

### DESCRIPTION OF EMBODIMENTS

Hereinafter, preferred embodiments of the present disclosure will be described using the drawings. The drawings used are for convenience of explanation. The embodiments described below do not unduly limit the details of the present disclosure described in the claims. In addition, all of the configurations described below are not necessarily essential components of the disclosure.

### 1. Structure of Liquid Ejection Apparatus

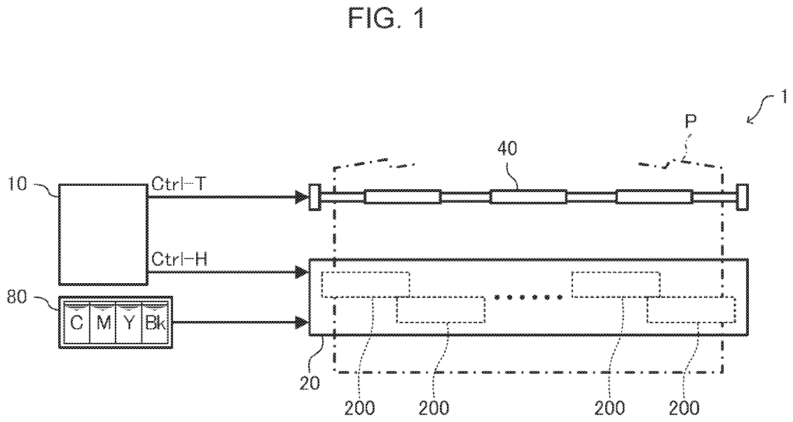

FIG. 1 is a diagram showing a schematic configuration of a liquid ejection apparatus 1. The liquid ejection apparatus 1 of the present embodiment is a so-called line printing type ink jet printer in which a print head 20 ejects ink at a predetermined timing onto a medium P that is transported along the transport direction to form a desired image on the medium P. Examples of the medium P used in such a liquid ejection apparatus 1 can include any printing target such as printing paper, resin film, and fabric cloth. Note that the liquid ejection apparatus 1 is not limited to a line printing type ink jet printer, but may be a serial printing type ink jet printer. Furthermore, the liquid ejection apparatus 1 is not limited to an ink jet printer, but may also be a coloring material ejection device used for manufacturing color filters for a liquid crystal display, and the like, a electrode material ejection device used for forming electrodes such as an organic EL display, an surface emitting display (FED), and the like, a biological organic matter ejection device used in biochip production, a three-dimensional modeling device, a printing equipment, or the like.

As shown in FIG. 1, the liquid ejection apparatus 1 includes a control unit 10, a print head 20, a transport unit 40, and an ink container 80.

The ink container 80 stores a plurality of types of ink to be ejected onto the medium P, for example, cyan C, magenta M, yellow Y, and black Bk. Examples of the ink container 80 in which such ink is stored can include an ink cartridge, a bag-shaped ink pack formed of a flexible film, and an ink tank that can be refilled with ink.

The control unit 10 includes a processing circuit such as a central processing unit (CPU) and a field programmable gate array (FPGA), and a storage circuit such as a semiconductor memory, and controls respective components, including the print head 20, of the liquid ejection apparatus 1.

Print head 20 includes a plurality of ejection heads 200. The plurality of ejection heads 200 is disposed in parallel along a scanning axis that intersects with the transport direction of the medium P so that the width thereof is at least greater than the width of the medium P to be transported. A control signal Ctrl-H output from the control unit 10 is input to the print head 20. Furthermore, the ink stored in the ink container 80 is supplied to the print head 20 via a tube (not shown). The print head 20 then ejects ink supplied from the ink container 80 based on the input control signal Ctrl-H.

The transport unit 40 transports the medium P along the transport direction by operating based on a control signal Ctrl-T input from the control unit 10.

In the liquid ejection apparatus 1 configured as described above, the print head 20 ejects ink onto the medium P in conjunction with the transport of the medium P by the transport unit 40. As a result, the ink lands on an any position on the medium P, and a desired image is formed on the medium P.

### 2. Functional Configuration of Liquid Ejection Apparatus

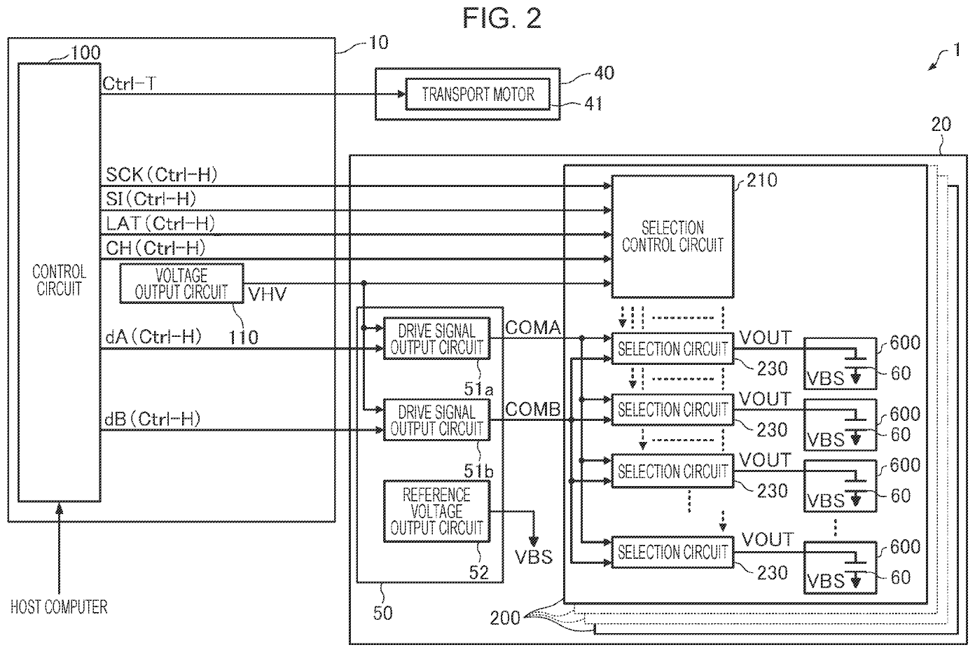

FIG. 2 is a diagram showing the functional configuration of the liquid ejection apparatus 1. As shown in FIG. 2, the liquid ejection apparatus 1 includes the control unit 10, the print head 20, and the transport unit 40.

The control unit 10 includes a control circuit 100 and a voltage output circuit 110.

When the control circuit 100 is supplied with an image signal from an external device such as a host computer, the control circuit 100 generates various control signals according to the image signal to output the generated control signals to the corresponding components.

Specifically, the control circuit 100 generates and outputs the control signal Ctrl-T when an image signal is supplied and a printing process on the medium P is executed. The control signal Ctrl-T output by the control circuit 100 is input to a transport motor 41 included in the transport unit 40. The transport motor 41 is driven according to the control signal Ctrl-T. The driving force of the transport motor 41 transports the medium P along the transport direction. Note that the transport unit 40 may include one or a plurality of transport rotors in addition to the transport motor 41. Further, the transport unit 40 may include a transport motor driver circuit for converting the control signal Ctrl-T into a predetermined signal for driving the transport motor 41.

The control circuit 100 a clock signal SCK, a print data signal SI, a latch signal LAT, a change signal CH, and base drive signals dA and dB as the control signal Ctrl-H based on an image signal supplied from an external device to output the generated signals to the print head 20.

The voltage output circuit 110 generates a DC voltage VHV of, for example, 42 V to output the generated voltage to the print head 20. The voltage VHV is used as a power supply voltage for various components of the print head 20. Furthermore, the voltage VHV output by the voltage output circuit 110 may be used as a power supply voltage for various components of the liquid ejection apparatus 1 including the control unit 10 and the transport unit 40. In addition to the voltage VHV that is a 42 V DC voltage, the voltage output circuit 110 may generate a plurality of DC voltages, such as a 5 V DC voltage and a 3.3 V DC voltage, and supply the generated voltages to the corresponding components.

The print head 20 includes a drive circuit 50 and a plurality of ejection heads 200.

The drive circuit 50 includes drive signal output circuits 51a and 51b. The digital base drive signal dA as the control signal Ctrl-H and the voltage VHV are input to the drive signal output circuit 51a. The drive signal output circuit 51a outputs a drive signal COMA by digital-to-analog converting the input base drive signal dA to class-D amplify the converted analog signal to a voltage value corresponding to the voltage VHV. The drive signal COMA output by the drive signal output circuit 51a is supplied to the ejection head 200. Similarly, the digital base drive signal dB as the control signal Ctrl-H and the voltage VHV are input to the drive signal output circuit 51b. The drive signal output circuit 51b outputs a drive signal COMB by digital-to-analog converting the input base drive signal dB to class-D amplify the converted analog signal to a voltage value corresponding to the voltage VHV. The drive signal COMB output by the drive signal output circuit 51b is supplied to the ejection head 200.

That is, the base drive signal dA is a signal that is a base of the drive signal COMA and defines the waveform of the drive signal COMA, and the base drive signal dB is a signal that is a base of the drive signal COMB and defines the waveform of the drive signal COMB. Here, the base drive signals dA and dB may be signals that can define the waveforms of the drive signals COMA and COMB, and may be analog signals.

Furthermore, drive circuit 50 includes a reference voltage output circuit 52. The reference voltage output circuit 52 generates a reference voltage signal VBS, which is a constant DC voltage with a voltage value of 5.5 V, 6 V, or the like, to output the generated signal to the ejection head 200. The reference voltage signal VBS functions as a reference potential for driving a piezoelectric element 60 that is included in the ejection head 200 and will be described later. The potential of such a reference voltage signal VBS is not limited to 5.5 V or 6 V, but may be a ground potential.

The ejection head 200 includes a selection control circuit 210, a plurality of selection circuits 230, and a plurality of ejection units 600 corresponding to the plurality of respective selection circuits 230.

The selection control circuit 210 receives the clock signal SCK as the control signal Ctrl-H, the print data signal SI, the latch signal LAT, and the change signal CH. The selection control circuit 210 generates a selection signal corresponding to each of the plurality of selection circuits 230 based on the clock signal SCK, the print data signal SI, the latch signal LAT, and the change signal CH that are input, and outputs the generated selection signal to the corresponding selection circuit 230.

Each selection circuit 230 receives the drive signals COMA and COMB and a corresponding selection signal output from the selection control circuit 210. By selecting or deselecting the waveforms of the drive signals COMA and COMB based on the input selection signal, the selection circuit 230 generates a drive signal VOUT based on the drive signals COMA and COMB to output the generated drive signal VOUT to the corresponding ejection unit 600.

Each of the plurality of ejection units 600 includes the piezoelectric element 60. One end of the piezoelectric element 60 is supplied with the drive signal VOUT output from the corresponding selection circuit 230, and the other end is supplied with the reference voltage signal VBS. The piezoelectric element 60 is driven according to the potential difference between the drive signal VOUT supplied to one end and the reference voltage signal VBS supplied to the other end. An amount of ink corresponding to driving of the piezoelectric element 60 is ejected from the ejection unit 600.

Here, in the liquid ejection apparatus 1 according to the present embodiment, the plurality of ejection heads 200 included in the print head 20 includes a total of 5000 or more ejection units 600, and the 5000 or more ejection units 600 included in the print head 20 are supplied with drive signals COMA and COMB output from one drive circuit 50. That is, the drive signal output circuits 51a and 51b supply drive signals COMA and COMB to 5000 or more piezoelectric elements 60 included in the plurality of ejection heads 200.

When performing printing at 600 dpi on the medium P, which is an A4 size (210 mm×297 mm: 8.27 inch×11.69 inch) sheet, in a line printing type ink jet printer as shown in the present embodiment, the print head 20 includes at least “600/inch×8.27 inch=4962” ejection units 600 disposed in parallel along the scanning axis. At this time, since the liquid ejection apparatus 1 includes a plurality of ejection heads 200, when viewed along the transport direction of the medium P, the plurality of ejection heads 200 is installed with part of each of them overlapping each other as shown in FIG. 1. Therefore, when viewed along the transport direction of the medium P, part of each of the ejection units 600 overlap each other. Further, the plurality of ejection units 600 need to be disposed in the print head 20 in consideration of the bending of the medium P transported by the transport unit 40 and the like.

Considering this point, when a line printing type ink jet printer as shown in the present embodiment performs printing at 600 dpi on the medium P, which is an A4 size sheet, the print head 20 includes at least 5000 or more ejection units 600 in the short side direction of the medium P, and in a direction along the scanning axis.

One drive circuit 50 supplies drive signals COMA and COMB to the 5000 or more piezoelectric elements 60 that such a print head 20 has, so that the ejection units 600 disposed in parallel in the direction along the scanning axis is driven by the drive signal VOUT based on drive signals COMA and COMB having the same signal waveform. This reduces the possibility that the signal waveforms of the drive signals VOUT supplied to the ejection units 600 disposed in parallel in the direction along the scanning axis will vary. As a result, the possibility of variations in the amount of ink ejected from the ejection units 600 disposed in parallel in the direction along the scanning axis due to variations in signal waveforms is reduced, so that the accuracy of ejection of the ink ejected from the print head 20 is improved, and the quality of the image formed on the medium P is improved.

As described above, the liquid ejection apparatus 1 according to the present embodiment includes the ejection head 200 that ejects a liquid according to driving of the piezoelectric element 60, the drive signal output circuit 51a and 51b that outputs the drive signals COMA and COMB that drive the piezoelectric element 60, and the control circuit 100 that outputs the base drive signals dA and dB, which are the bases of drive signals COMA and COMB.

### 3. Structure of Ejection Unit

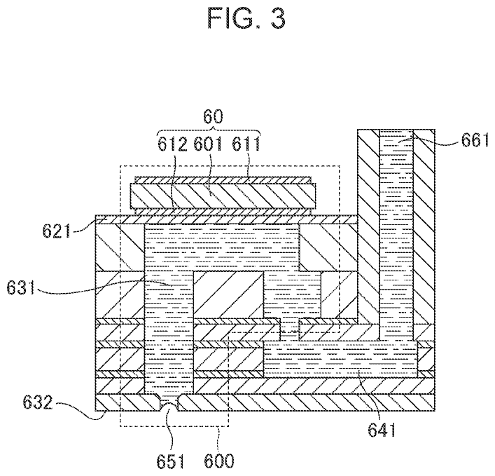

Here, an example of the structure of the ejection unit 600 included in the ejection head 200 will be described. FIG. 3 is a diagram showing a schematic structure of one of the plurality of ejection units 600 included in the ejection head 200. As shown in FIG. 3, the ejection unit 600 includes the piezoelectric element 60, a vibration plate 621, a cavity 631, and a nozzle 651.

The cavity 631 is filled with the ink supplied from a reservoir 641. Further, the ink is introduced into the reservoir 641 from the ink container 80 via an ink tube (not shown) and a supply port 661. That is, the cavity 631 is filled with the ink stored in the corresponding liquid container 5.

The vibration plate 621 is displaced by driving the piezoelectric element 60 provided on the upper face in FIG. 3. With the displacement of the vibration plate 621, the internal volume of the cavity 631 filled with the ink expands or contracts. That is, the vibration plate 621 functions as a diaphragm that changes the internal volume of the cavity 631.

The nozzle 651 is an opening provided in the nozzle plate 632 and communicating with the cavity 631. When the internal volume of the cavity 631 changes, an amount of the ink corresponding to the change in the internal volume is ejected from the nozzle 651.

The piezoelectric element 60 has a structure in which a piezoelectric body 601 is sandwiched between a pair of electrodes 611 and 612. In the piezoelectric body 601 having such a structure, the central portions of the electrodes 611 and 612 bend together with the vibration plate 621 in the vertical direction according to the potential difference of the voltage supplied by the electrodes 611 and 612. Specifically, the drive signal VOUT is supplied to one of the electrodes 611 and 612 of the piezoelectric element 60. Further, the reference voltage signal VBS is supplied to the other of the electrode 611 and the electrode 612 of the piezoelectric element 60. The piezoelectric element 60 bends upward when the voltage level of the drive signal VOUT increases, and bends downward when the voltage level of the drive signal VOUT decreases.

In the ejection unit 600 configured as described above, when the piezoelectric element 60 bends upward, the vibration plate 621 is displaced to increase the internal volume of the cavity 631. As a result, the ink is drawn from the reservoir 641. On the other hand, when the piezoelectric element 60 bends downward, the vibration plate 621 is displaced to reduce the internal volume of the cavity 631. As a result, an amount of ink corresponding to the degree of reduction is ejected from the nozzle 651. That is, the ejection head 200 includes the electrode 611 and the electrode 612, includes the piezoelectric element 60 driven by the potential difference between the electrode 611 and the electrode 612, and ejects the ink by driving the piezoelectric element 60.

The piezoelectric element 60 is not limited to the structure shown in FIG. 3, but may have any structure as long as it can eject the ink from the ejection unit 600. That is, the piezoelectric element 60 is not limited to the above-described configuration of the bending vibration, but may be, for example, a configuration using the longitudinal vibration.

### 4. Configuration of Drive Signal Output Circuit

Next, the configuration and the operation of the drive signal output circuits 51a and 51b included in the drive circuit 50 will be described. Here, the drive signal output circuits 51a and 51b have the same configuration except that the input signal and the output signal are different. Therefore, in the following description, the configuration and the operation of the drive signal output circuit 51a that outputs the drive signal COMA based on the base drive signal dA will be described, and the detailed description of the configuration and the operation of the drive signal output circuit 51b that outputs the drive signal COMB based on the base drive signal dB will be omitted.

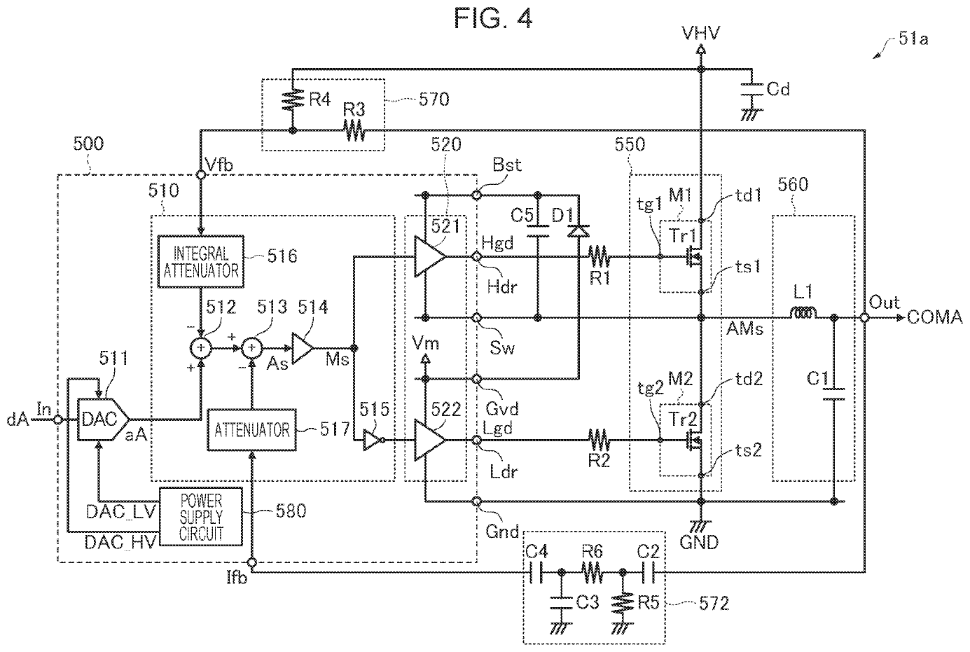

FIG. 4 is a diagram showing the configuration of the drive signal output circuit 51a. As shown in FIG. 4, the drive signal output circuit 51a includes an integrated circuit 500 including a modulation circuit 510, an amplifier circuit 550, a demodulation circuit 560, feedback circuits 570 and 572, and a plurality of other circuit elements. The integrated circuit 500 outputs a gate signal Hgd and a gate signal Lgd based on the base drive signal dA, which is the base of the drive signal COMA. The amplifier circuit 550 includes a switching element M1 driven by the gate signal Hgd and a switching element M2 driven by the gate signal Lgd, and generates the amplified modulation signal AMs to output the generated amplified modulation signal AMs to the demodulation circuit 560. The demodulation circuit 560 smooths the amplified modulation signal AMs to output the smoothed amplified modulation signal as the drive signal COMA.

The integrated circuit 500 is electrically coupled to the outside of the integrated circuit 500 through a plurality of terminals including a terminal In, a terminal Bst, a terminal Hdr, a terminal Sw, a terminal Gvd, a terminal Ldr, a terminal Gnd, a terminal Ifb, and a terminal Vfb. The integrated circuit 500 modulates the base drive signal dA input from the terminal In, outputs the gate signal Hgd that drives the switching element M1 included in the amplifier circuit 550 from the terminal Hdr, and outputs the gate signal Lgd that drives the switching element M2 from the terminal Ldr. That is, the integrated circuit 500 receives the base drive signal dA to output the gate signal Hgd and the gate signal Lgd.

The integrated circuit 500 includes a digital to analog converter (DAC) 511, the modulation circuit 510, a gate drive circuit 520, and a power supply circuit 580.

The power supply circuit 580 generates a voltage DAC_HV and a voltage DAC_LV and supplies the generated voltages to the DAC 511.

The DAC 511 converts the digital base drive signal dA that defines the signal waveform of the drive signal COMA into the base drive signal aA, which is an analog signal with a voltage value between the voltage DAC_HV and the voltage DAC_LV, to output the converted digital base drive signal to the modulation circuit 510. Note that the maximum value of the voltage amplitude of the base drive signal aA is defined by the voltage value of the voltage DAC_HV, and the minimum value is defined by the voltage value of the voltage DAC_LV. That is, the voltage DAC_HV is a reference voltage of the DAC 511 on the high voltage side, and the voltage DAC_LV is a reference voltage of the DAC 511 on the low voltage side. A signal obtained by amplifying the analog base drive signal aA output from the DAC 511 corresponds to the drive signal COMA. That is, the base drive signal aA corresponds to the target analog signal of the drive signal COMA before amplification, and the base drive signal dA corresponds to the target digital signal of the drive signal COMA before amplification. Note that the voltage amplitude of the base drive signal aA in the present embodiment is, for example, 1 V to 2 V.

The modulation circuit 510 generates a modulation signal Ms obtained by modulating the base drive signal aA to output the generated modulation signal Ms to the amplifier circuit 550 via the gate drive circuit 520. The modulation circuit 510 includes adders 512 and 513, a comparator 514, an inverter 515, an integral attenuator 516, and an attenuator 517.

The integral attenuator 516 attenuates and integrates the voltage value of a terminal Out input via the terminal Vfb, that is, the value of the drive signal COMA, and supplies the attenuated and integrated voltage value to a negatives input end of the adder 512. The base drive signal aA is input to a positive input end of the adder 512. The adder 512 supplies a voltage obtained by subtracting and integrating the voltage input to the negative input end from the voltage input to the positive input end to the positive input end of the adder 513.

Here, while the maximum value of the voltage amplitude of the base drive signal aA is about 2 V as described above, the maximum value of the voltage of the drive signal COMA may exceed 40 V. For this reason, the integral attenuator 516 attenuates the voltage of the drive signal COMA input via the terminal Vfb in order to match the amplitude ranges of both voltages when obtaining the deviation.

The attenuator 517 supplies a voltage obtained by attenuating the high-frequency component of the drive signal COMA input via the terminal Ifb to the negative input end of the adder 513. Further, the voltage output from the adder 512 is input to the positive input end of the adder 513. The adder 513 outputs to the comparator 514 a voltage As obtained by subtracting the voltage input to the negative input end from the voltage input to the positive input end.

The voltage As output from the adder 513 is a voltage obtained by subtracting the voltage of the signal supplied to the terminal Vfb and further subtracting the voltage of the signal supplied to the terminal Ifb from the voltage of the base drive signal aA. For this reason, the voltage of the voltage As output from the adder 513 is a signal obtained by correcting the deviation obtained by subtracting the attenuation voltage of the drive signal COMA from the voltage of the base drive signal aA as the target signal by the high-frequency component of the drive signal COMA.

The comparator 514 outputs the pulse-modulated modulation signal Ms based on the voltage As output from the adder 513. Specifically, the comparator 514 outputs the modulation signal Ms which is at H level when the voltage As output from the adder 513 is equal to or higher than a threshold value Vth1 described later in a case where the voltage is rising, and is at L level when the voltage As falls below a threshold value Vth2 described later in a case where the voltage is dropping. Here, the threshold values Vth1 and Vth2 are set in a relationship in which the threshold value Vth1 is greater than the threshold value Vth2. The frequency and the duty ratio of the modulation signal Ms change in accordance with the base drive signals dA and aA. Therefore, the attenuator 517 adjusts the modulation gain corresponding to the sensitivity, so that the change amount of the frequency or the duty ratio of the modulation signal Ms can be adjusted.

The modulation signal Ms output from the comparator 514 is supplied to a gate driver 521 included in the gate drive circuit 520. The modulation signal Ms is supplied to a gate driver 522 included in the gate drive circuit 520 after the logic level is inverted by the inverter 515. That is, the logic level of the signal supplied to the gate driver 521 and the logic level of the signal supplied to the gate driver 522 are mutually in a exclusive relationship.

Here, the timing may be controlled so that the logic levels of the signals supplied to the gate driver 521 and the gate driver 522 do not become H level at the same time. That is, the exclusive relationship means that the logic levels of the signals supplied to the gate driver 521 and the gate driver 522 are not H level at the same time. For details, this means that the switching element M1 and the switching element M2 included in the amplifier circuit 550 are not turned “ON” at the same time.

The gate drive circuit 520 includes the gate driver 521 and the gate driver 522.

The gate driver 521 shifts the level of the modulation signal Ms output from the comparator 514 to output the level-shifted modulation signal Ms as the gate signal Hgd from the terminal Hdr. The higher side of the power supply voltage of the gate driver 521 is a voltage applied via the terminal Bst, and the lower side is a voltage applied via the terminal Sw. The terminal Bst is coupled to one end of a capacitor C5 and the cathode of a diode D1. The terminal Sw is coupled to the other end of the capacitor C5. The anode of the diode D1 is coupled to the terminal Gvd. As a result, a voltage Vm that is a DC voltage of, for example, 7.5 V supplied from a power supply circuit (not shown) is supplied to the anode of the diode D1. Therefore, the potential difference between the terminal Bst and the terminal Sw is approximately equal to the potential difference between both ends of the capacitor C5, that is, the voltage Vm. The gate driver 521 generates the gate signal Hgd having a voltage higher than, by the voltage Vm, that of the terminal Sw according to the input modulation signal Ms to output the generated gate signal Hgd from the terminal Hdr.

The gate driver 522 operates at a lower potential than the gate driver 521. The gate driver 522 shifts the level of the signal obtained by inverting, by the inverter 515, the logic level of the modulation signal Ms output from the comparator 514 to output the level-shifted signal as the gate signal Lgd from the terminal Ldr. Among the power supply voltages of the gate driver 522, the voltage Vm is applied to the higher side, and a ground potential of 0 V, for example, is supplied to the lower side through the terminal Gnd. The gate signal Lgd having a voltage higher than, by the voltage Vm, that of the terminal Gnd according to the signal input to the gate driver 522 is generated and is output from the terminal Ldr.

Here, the gate signal Hgd is a signal obtained by-shifting the level of the voltage value of the modulation signal Ms, and the gate signal Lgd is a signal obtained by inverting the logic level of the modulation signal Ms and then-shifting the level of the voltage value of the inverted signal. In view of this, the gate signal Hgd and the gate signal Lgd also correspond to signals obtained by modulating the base drive signal dA and the base drive signal aA.

The amplifier circuit 550 Includes The Switching Elements M1 And M2. The switching element M1 is a semiconductor device such as a field effect transistor (FET), and includes a transistor chip Tr1 in which the FET is formed, a terminal tg1 electrically coupled to the gate of the transistor chip Tr1, a terminal td1 electrically coupled to the drain of the transistor chip Tr1, and a terminal ts1 electrically coupled to the source of the transistor chip Tr1. The voltage VHV, which is a DC voltage of 42 V, for example, is supplied to the terminal td1 of the switching element M1. The terminal tg1 of the switching element M1 is electrically coupled to one end of a resistor R1, and the other end of the resistor R1 is electrically coupled to the terminal Hdr of the integrated circuit 500. That is, the gate signal Hgd output from the terminal Hdr of the integrated circuit 500 is supplied to a terminal tg of the switching element M1. The terminal ts1 of the switching element M1 is electrically coupled to the terminal Sw of the integrated circuit 500. That is, the switching element M1 includes the transistor chip Tr1, and the terminal tg1, the terminal ts1, and the terminal td1 that are electrically coupled to the transistor chip Tr1.

In the switching element M1 configured as described above, the gate signal Hgd input to the terminal tg1 is supplied to the drain of the transistor chip Tr1. As a result, the conduction state between the drain and source of the transistor chip Tr1 and between the terminal td1 and the terminal ts1 of the switching element M1 is controlled. That is, the switching element M1 is operated by the gate signal Hgd. Specifically, in the switching element M1, the conduction state between the terminal ts1 and the terminal td1 is controlled according to the gate signal Hgd input to the terminal tg1. Here, in the following description, a state that is controlled to be conductive between the terminal td1 and the terminal ts1 of the switching element M1 may be referred to as “ON”, and a state that is controlled to be non-conductive between the terminal td1 and the terminal ts1 of the switching element M1 may be referred to as “OFF”.

The switching element M2 is a semiconductor device such as an FET, and includes a transistor chip Tr2 in which the FET is formed, a terminal tg2 electrically coupled to the gate of the transistor chip Tr2, a terminal td2 electrically coupled to the drain of the transistor chip Tr2, and a terminal ts2 electrically coupled to the source of the transistor chip Tr2. A terminal td2 of the switching element M2 is electrically coupled to the terminal Sw of the integrated circuit 500. That is, the terminal td2 of the switching element M2 and the terminal ts1 of the switching element M1 are electrically coupled to each other. The terminal tg2 of the switching element M2 is electrically coupled to one end of a resistor R2, and the other end of the resistor R2 is electrically coupled to the terminal Ldr of the integrated circuit 500. That is, the gate signal Lgd output from the terminal Ldr of the integrated circuit 500 is supplied to the terminal tg2 of the switching element M2. A ground potential is supplied to the terminal ts2 of the switching element M2. That is, the switching element M2 includes the transistor chip Tr2, and the terminal tg2, the terminal ts2, and the terminal td2 that are electrically coupled to the transistor chip Tr2.

In the switching element M2 configured as described above, the gate signal Lgd input to the terminal tg2 is supplied to the drain of the transistor chip Tr2. As a result, the conduction state between the drain and source of the transistor chip Tr2 and between the terminal td2 and the terminal ts2 of the switching element M2 is controlled. That is, the switching element M2 is operated by the gate signal Lgd. Specifically, in the switching element M2, the conduction state between the terminal td2 and the terminal ts2 is controlled according to the gate signal Lgd input to the terminal tg2. Here, in the following description, a state that is controlled to be conductive between the terminal td2 and the terminal ts2 of the switching element M2 may be referred to as “ON”, and a state that is controlled to be non-conductive between the terminal td2 and the terminal ts2 of the switching element M2 may be referred to as “OFF”.

In the amplifier circuit 550 configured as described above, when the switching element M1 is controlled to be “OFF” and the switching element M2 is controlled to be “ON”, the voltage at the node to which the terminal Sw is coupled is the ground potential. At this time, the voltage Vm is supplied to the terminal Bst. On the other hand, when the switching element M1 is controlled to be “ON” and the switching element M2 is controlled to be “OFF”, the voltage at the node to which the terminal Sw is coupled is the voltage VHV. Therefore, a voltage signal having a potential of the voltage VHV+Vm is supplied to the terminal Bst.

That is, the gate driver 521 that drives the switching element M1 uses the capacitor C5 as a floating power supply, and when the potential of the terminal Sw at the other end of the capacitor C5 changes to 0 V or the voltage VHV, the gate driver 521 supplies the gate signal Hgd whose L level is a potential of the voltage VHV and whose H level is a potential of the voltage VHV+voltage Vm to the gate terminal of the switching element M1 according to the operations of the switching element M1 and the switching element M2.

On the other hand, the gate driver 522 that drives the switching element M2 supplies the gate signal Lgd whose L level is the ground potential and whose H level is a potential of the voltage Vm the gate terminal of the switching element M2, regardless of the operations of the switching element M1 and the switching element M2.

As described above, the amplifier circuit 550 amplifies a modulation signal Ms obtained by the base drive signals dA and aA being modulated based on the voltage VHV by operating the switching elements M1 and M2 in accordance with the gate signals Hgd and Lgd. Then, the amplifier circuit 550 outputs the amplified signal as an amplified modulation signal AMs from a coupling point where the terminal ts1 of the switching element M1 and the terminal td2 of the switching element M2 are commonly coupled.

Further, as shown in FIG. 4, a capacitor Cd is located on a propagation path through which the voltage VHV input to the amplifier circuit 550 propagates. The voltage VHV is supplied to one end of the capacitor Cd, and the ground potential is supplied to the other end. The capacitor Cd is, for example, an electrolytic capacitor, and reduces the possibility that the potential of the voltage VHV will fluctuate due to the operation of the amplifier circuit 550.

The demodulation circuit 560 generates the drive signal COMA by smoothing the amplified modulation signal AMs output from the amplifier circuit 550 to output the generated drive signal COMA from the drive signal output circuit 51a.

The demodulation circuit 560 includes a coil L1 and a capacitor C1. One end of the coil L1 is electrically coupled to the terminal ts1 of the switching element M1 and the terminal td2 of the switching element M2. As a result, the amplified modulation signal AMs output from the amplifier circuit 550 is input to one end of the coil L1. Further, the other end of the coil L1 is coupled to the terminal Out that serves as an output of the drive signal output circuit 51a. Further, the other end of the coil L1 is also coupled to one end of the capacitor C1. The ground potential is supplied to the other end of the capacitor C1. That is, the coils L1 and the capacitor C1 smooth the amplified modulation signal AMs output from the amplifier circuit 550 to demodulate the signal, and output the demodulated signal as the drive signal COMA.

The feedback circuit 570 includes a resistor R3 and a resistor R4. One end of the resistor R3 is coupled to the terminal Out from which the drive signal COMA is output, and the other end is coupled to the terminal Vfb and one end of the resistor R4. The voltage VHV is supplied to the other end of the resistor R4. As a result, the drive signal COMA that has passed through the feedback circuit 570 from the terminal Out is fed back to the terminal Vfb in a pulled-up state.

The feedback circuit 572 includes capacitors C2, C3, C4 and resistors R5, R6. One end of the capacitor C2 is coupled to the terminal Out from which the drive signal COMA is output, and the other end is coupled to one end of the resistor R5 and one end of the resistor R6. The ground potential is supplied to the other end of the resistor R5. Thus, the capacitor C2 and the resistor R5 function as a high pass filter. The cut-off frequency of the high pass filter is set to, for example, about 9 MHZ. The other end of the resistor R6 is coupled to one end of the capacitor C4 and one end of the capacitor C3. The ground potential is supplied to the other end of the capacitor C3. Thus, the resistor R6 and the capacitor C3 function as a low pass filter. The cut-off frequency of the low pass filter is set to, for example, about 160 MHz. In this way, the feedback circuit 572 includes the high pass filter and the low pass filter, so that the feedback circuit 572 functions as a bandpass filter that passes a predetermined frequency range of the drive signal COMA.

The other end of capacitor C4 is coupled to the terminal Ifb of the integrated circuit 500. As a result, a signal obtained by cutting the DC component out of the high-frequency components of the drive signal COMA that has passed through the feedback circuit 572 that functions as the bandpass filter that passes a predetermined frequency component is fed back to the terminal Ifb.

The drive signal COMA output from the terminal Out a signal obtained by smoothing the amplified modulation signal AMs based on the base drive signal dA by the demodulation circuit 560. The drive signal COMA is integrated/subtracted via the terminal Vfb, and then fed back to the adder 512. Therefore, the drive signal output circuit 51a self-excited-oscillates at a frequency determined by the feedback delay and the feedback transfer function. However, since the feedback path via the terminal Vfb has a large delay amount, so that the frequency of the self-excited oscillation may not be made high enough to ensure the accuracy of the drive signal COMA simply by the feedback via the terminal Vfb. Therefore, the delay in the entire circuit is reduced by providing a path through which the high-frequency component of the drive signal COMA is fed back via the terminal Ifb separately from the path via the terminal Vfb. As a result, the frequency of the voltage As can be made high enough to ensure the accuracy of the drive signal COMA as compared with the case where there is no path via the terminal Ifb.

Here, it is preferable that the oscillation frequency of self-excited oscillation in the drive signal output circuit 51a in the present embodiment be 1 MHz or more and 8 MHz or less from the viewpoint of reducing the heat generated in the drive signal output circuit 51a while sufficiently ensuring the accuracy of the drive signal COMA, and particularly when reducing the power consumption of the liquid ejection apparatus 1, it is preferable that the oscillation frequency of self-excited oscillation in the drive signal output circuit 51a be 1 MHz or more and 4 MHZ or less. In other words, the driving frequency of the switching elements M1 and M2 is preferably 1 MHz or more and 8 MHz or less from the viewpoint of reducing the heat generation generated in the switching elements M1 and M2, and furthermore, the driving frequency of the switching elements M1 and M2 is preferably 1 MHz or more and 4 MHz or less in a case where the power consumption of the liquid ejection apparatus 1 is reduced by reducing the loss generated in the switching elements M1 and M2.

In the liquid ejection apparatus 1 according to the present embodiment, the drive signal output circuit 51a smooths the amplified modulation signal AMs to generate the drive signal COMA, and supplies the generated drive signal COMA to the piezoelectric element 60 included in the print head 20. The piezoelectric element 60 is driven by being supplied with a signal waveform included in the drive signal COMA. Then, the amount of ink corresponding to driving of the piezoelectric element 60 is ejected from the ejection unit 600.

When a frequency spectrum analysis is performed on the signal waveform of the drive signal COMA that drives the piezoelectric element 60, it is known that the drive signal COMA contains a frequency component of 50 kHz or more. In order to accurately generate the signal waveform of the drive signal COMA that contains a frequency component of 50 kHz or more, when the frequency of the modulation signal is set to be lower than 1 MHZ, the edge portion of the signal waveform of the drive signal COMA output from the drive signal output circuit 51a will be dull and the dullness occurs. In other words, in order to accurately generate the signal waveform of the drive signal COMA, the frequency of the modulation signal Ms is required to be 1 MHz or more. When the driving frequencies of the switching elements M1 and M2 that are the oscillation frequency of the self-excited oscillation of the drive signal output circuit 51a are 1 MHz or less, the waveform accuracy of the drive signal COMA decreases, so that the driving accuracy of the piezoelectric element 60 decreases. As a result, the ejection characteristics of the ink ejected from the liquid ejection apparatus 1 may deteriorate.

To solve this problem, by setting the driving frequencies of the switching elements M1 and M2 that are the frequency of the modulation signal Ms and the oscillation frequency of self-excited oscillation of the drive signal output circuit 51a to 1 MHz or more, the possibility that the edge portion of the signal waveform of the drive signal COMA will be dull is reduces. That is, the waveform accuracy of the signal waveform of the drive signal COMA is improved, and the driving accuracy of the piezoelectric element 60 driven based on the drive signal COMA is improved. Therefore, the possibility that the ejection characteristics of the ink ejected from the liquid ejection apparatus 1 will deteriorate is reduced.

However, when the driving frequencies of the switching elements M1 and M2 that are the frequency of the modulation signal Ms and the oscillation frequency of self-excited oscillation of the drive signal output circuit 51a and are increased, the switching loss in the switching elements M1 and M2 increases. Such switching losses generated in the switching elements M1 and M2 increase the power consumption in the drive signal output circuit 51a and also increase the amount of heat generated in the drive signal output circuit 51a. That is, when the driving frequencies of the switching elements M1 and M2 that are the oscillation frequency of the self-excited oscillation of the drive signal output circuit 51a and are made too high, the switching loss in the switching elements M1 and M2 is large, and as a result, power saving and heat saving, which are one of the advantages of a class D amplifier in linear amplification over class A, B amplifiers, may be impaired. From the viewpoint of reducing the switching loss of such switching elements M1 and M2, the driving frequencies of the switching elements M1 and M2 that are the frequency of the modulation signal Ms and the oscillation frequency of self-excited oscillation of the drive signal output circuit 51a are preferably 8 MHz or less, and particularly when it is required to improve the power saving performance of the liquid ejection apparatus 1, the driving frequencies of the switching elements M1 and M2 are preferably 4 MHz or less.

From the above, from the viewpoint of achieving both improvement in the accuracy of the signal waveform of the output drive signal COMA and power saving in the drive signal output circuit 51a including a class D amplifier, it is preferable that the driving frequencies of the switching elements M1 and M2 that are the oscillation frequency of the self-excited oscillation of the drive signal output circuit 51a be 1 MHz or more and 8 MHz or less, and specifically, when reducing the power consumption of the liquid ejection apparatus 1, it is preferable that the driving frequencies of the switching elements M1 and M2 that are the oscillation frequency of the self-excited oscillation of the drive signal output circuit 51a be 1 MHz or more and 4 MHz or less.

Here, the driving frequencies of the switching elements M1 and M2 that are the oscillation frequency of self-excited oscillation of the drive signal output circuit 51a include the frequency of the modulation signal Ms described above, the frequencies of the gate signals Hgd and Lgd, the frequency of the amplified modulation signal AMs, and the like.

As described above, the drive signal output circuit 51a includes the integrated circuit 500 that receives the base drive signal dA to output the gate signals Hgd and Lgd, the switching element M1 that operates according to the gate signal Hgd, the switching element M2 that operates according to the gate signal Lgd, and the demodulation circuit 560, wherein the integrated circuit 500 outputs the gate signal Hgd and the gate signal Lgd according to the modulation signal Ms obtained by modulating the base drive signal dA, wherein the terminal ts1 of the switching element M1 and the terminal td2 of the switching element M2 are electrically coupled to each other, and wherein the demodulation circuit 560 demodulates a signal at the coupling point where the terminal ts1 and the terminal td2 are electrically coupled to output the demodulated signal as the drive signal COMA.

5. Structure of drive circuit board on which drive signal output circuit is mounted

Here, in the liquid ejection apparatus 1, most of the ink ejected from the nozzle 651 lands on the medium P to form an image. However, part of the ink ejected from the nozzle 651 turns into mist and floats inside the liquid ejection apparatus 1 before landing on the medium P. Further, even after the ink ejected from the nozzle 651 lands on the medium P, it may turn into mist and float due to air currents and the like generated as the medium P is transported. Since such ink mist floating inside the liquid ejection apparatus 1 in such a manner is extremely small, the ink mist is charged by the Lennard effect and is attracted to various circuits provided inside the liquid ejection apparatus 1. When the ink mist adheres to a circuit provided inside the liquid ejection apparatus 1, the stability of the operation of the liquid ejection apparatus 1 decreases.

Specifically, in the liquid ejection apparatus 1 of the present embodiment, the drive signal output circuits 51a and 51b supply drive signals COMA and COMB, respectively, to 5000 or more piezoelectric elements 60. Therefore, a large current flows through various circuits that generate the drive signals COMA and COMB from the voltage VHV included in the drive signal output circuits 51a and 51b, and propagation paths through which the drive signals COMA and COMB output from the drive signal output circuits 51a and 51b propagate, and as a result, a large amount of ink mist is attracted to the circuits and the wiring paths. When the ink mist adheres to various circuits that generate the drive signals COMA and COMB from the voltage VHV included in the drive signal output circuits 51a and 51b, or to the propagation paths through which the drive signals COMA and COMB output from the drive signal output circuits 51a and 51b propagate, the waveform accuracy of the signal waveforms of the drive signals COMA and COMB may decrease, and the accuracy of ejection of the ink from the print head 20 may deteriorate.

Therefore, in the liquid ejection apparatus 1, it is required to reduce the possibility that the ink mist adheres to various circuits that generate the drive signals COMA and COMB from the voltage VHV included in the drive signal output circuits 51a and 51b, and propagation paths through which the drive signals COMA and COMB propagate, especially, the exposed charging portion where the charging portion is exposed.

In response to such a requirement, the liquid ejection apparatus 1 of the present embodiment includes drive signal output circuits 51a and 51b that can reduce the possibility that the ink mist adheres to the charging portion. An example of the structure of the drive signal output circuits 51a and 51b that can reduce the possibility of the ink mist adhering to the charging portion will be described below. Note that, as described above, the drive signal output circuits 51a and 51b have the same configuration, and the following description will be given using the drive signal output circuit 51a, and the description of the structure of the drive signal output circuit 51b will be omitted.

In describing an example of the structure of the drive signal output circuits 51a and 51b, first, the structure of the switching elements M1 and M2 included in the drive signal output circuits 51a and 51b of the present embodiment will be described. Note that the switching elements M1 and M2 have the same structure, and in the following description, when there is no need to distinguish between the switching elements M1 and M2, they may be simply referred to as a switching element M. At this time, description is made as the switching element M including a transistor chip Tr corresponding to the transistor chip Tr1 of the switching element M1 and the transistor chip Tr2 of the switching element M2, a terminal tg corresponding to the terminal tg1 of the switching element M1 and the terminal the terminal tg2 of the switching element M2, a terminal td corresponding to the terminal td1 of the switching element M1 and the terminal td2 of the switching element M2, and a terminal ts corresponding to the terminal ts1 of the switching element M1 and the terminal ts2 of the switching element M2.

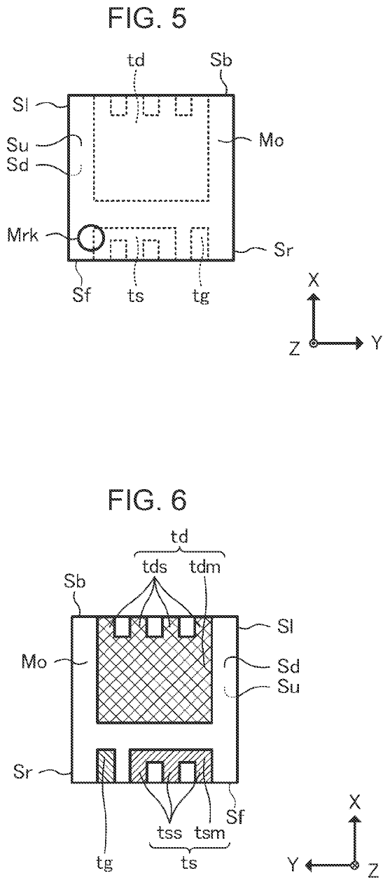

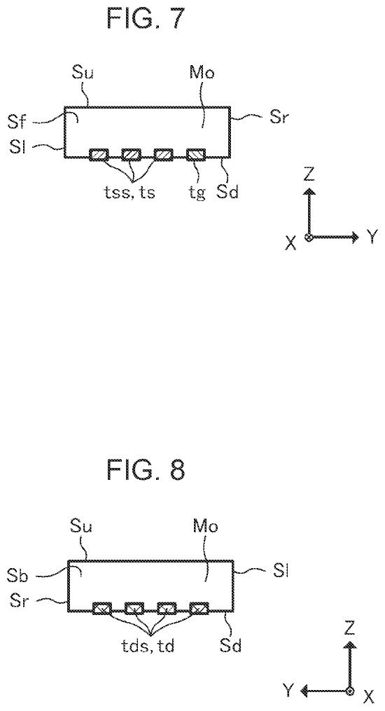

FIGS. 5 to 8 are diagrams showing an example of the structure of the switching element M. Here, the following description will be made using the X-axis, Y-axis, and Z-axis that are orthogonal to each other. In addition, in the following description, when defining a direction along the X-axis, the starting point of the arrow may be referred to as the −X side and the ending point is referred to as the +X side, when defining a direction along the Y-axis, the starting point of the arrow may be referred to as the −Y side and the ending point is referred to as the +Y side, and when defining a direction along the Z-axis, the starting point of the arrow may be referred to as the −Z side and the ending point is referred to as the +Z side.

As shown in FIGS. 5 to 8, the switching element M includes the mold portion Mo and the terminals tg, td, and ts provided around the mold portion Mo.

The mold portion Mo is a substantially hexahedron having faces Su, Sd, Sf, Sb, Sl, and Sr. Specifically, the face Su and the face Sd are located facing each other along the Z-axis so that the face Sd is on the −Z side and the face Su is on the +Z side, the face Sf and the face Sb are located facing each other along the X-axis so that the face Sf is on the −X side and the face Sb is on the +X side, and the face Sl and the face Sr are located facing each other along the Y-axis so that the face Sl is on the −Y side and the face Sr is on the +Y side.

Further, a reference direction mark Mrk is provided on the face Su of the mold portion Mo. The reference direction mark Mrk is a mark that indicates the position of a reference terminal that serves as a reference among the terminals tg, td, and ts that the switching element M has, and is provided at the position corresponding to the terminal ts in the case of the switching element M of the present embodiment. That is, the mold portion Mo includes the reference direction mark Mrk indicating the direction of the switching element M. Such a reference direction mark Mrk may be formed by, for example, embossing the mold portion Mo, or may have specific characters or symbols printed on the mold portion Mo.

The above-described transistor chip Tr is located inside such a mold portion Mo. That is, the mold portion Mo covers the transistor chip Tr. As a result, the mold portion Mo protects the transistor chip Tr from external impact and the outside air, and insulates the transistor chip Tr.

Here, there are a wide variety of liquids used in the liquid ejection apparatus 1, and examples of the liquid include the solvent-based ink such as solvent ink that includes an organic solvent as a solvent, and ultraviolet curing ink that is cured by irradiation with ultraviolet light in addition to water-based ink that includes water as a solvent such as water-based pigment ink and water-based dye ink. Therefore, the physical properties of the ink mist floating inside the liquid ejection apparatus 1 vary widely, and the mold portion Mo is required to have high resistance to physical properties of a wide variety of different liquids. Specifically, when the solvent-based ink including an organic solvent as a solvent is used, the organic solvent reacts with the mold portion Mo, dissolving the mold portion Mo and may reduce the reliability of the drive signal output circuits 51a and 51b.

In the liquid ejection apparatus 1 of the present embodiment, an epoxy resin containing polybutadiene having a glycidyl group is used for the mold portion Mo of each of the switching elements M1 and M2 of the drive signal output circuits 51a and 51b. That is, the mold portion Mo of each of the switching elements M1 and M2 is made of an epoxy resin containing glycidyl group polybutadiene. As a result, the mold portion Mo has high resistance to physical properties of a wide variety of different liquids, and even when the solvent-based ink is used and drips, the possibility that the mold portion Mo will dissolve is reduced. As a result, even when the liquid ejection apparatus 1 is used for a long period of time, the reliability of the switching elements M1 and M2 and the drive signal output circuits 51a and 51b including the switching elements M1 and M2 can be improved.

When viewing the switching element M from the +Z side to the −Z side along the Z-axis, that is, when viewing a mold portion Mo from the face Su to the face Sd, all of the terminal tg, the terminal ts, and the terminal td are provided at positions overlapping with the face Su of the mold portion Mo. In other words, when viewing the switching element M from the +Z side to the −Z side along the Z-axis, that is, when viewing the mold portion Mo from the face Su to the face Sd, the terminal tg, the terminal ts, and the terminal td are provided only at positions overlapping with the face Su of the mold portion Mo, and are not provided at positions that do not overlap with the face Su of the mold portion Mo. That is, when viewing the switching element M from the +Z side to the −Z side, that is, when viewing the mold portion Mo from the face Su to the face Sd, the terminal tg, the terminal ts, and the terminal td do not protrude from the mold portion Mo in any of the +X side, −X side, +Y side, and −Y side.

Specifically, the terminal td includes an electrode tdm and four electrodes tds. The electrode tdm is formed on the face Sd of the mold portion Mo. Each of the four electrodes tds is located on the +X side relative to the electrode tdm, and is disposed in parallel along the Y-axis with the −X side in contact with the electrode tdm. At this time, each of the four electrodes tds is formed from the face Sd to the face Sb of the mold portion Mo. Moreover, a region, of the face Sb of the mold portion Mo, where the four electrodes tds are located has a recessed portion. That is, the four electrodes tds included in the terminal td are located corresponding to the four recessed portions, respectively, formed in the face Sb. As a result, when viewing the switching element M from the +Z side to the −Z side along the Z-axis, that is, when viewing the mold portion Mo from the face Su to the face Sd, the terminal td does not protrude from the mold portion Mo in the +X side, and is provided only at a position overlapping with the face Su of the mold portion Mo.

The terminal ts includes an electrode tsm and three electrodes tss. The electrode tsm is formed on the −X side relative to the electrode tdm on the face Sd of the mold portion Mo. Each of the three electrodes tss is located on the −X side of the electrode tsm, and is disposed in parallel along the Y-axis with the +X side in contact with the electrode tdm. At this time, each of the three electrodes tss is formed from the face Sd to the face Sf of the mold portion Mo. Moreover, a region, of the face Sf of the mold portion Mo, where the three electrodes tss are located has a recessed portion. That is, the three electrodes tss included in the terminal ts are located corresponding to the three recessed portions, respectively, formed in the face Sf. As a result, when viewing the switching element M from the +Z side to the −Z side along the Z-axis, that is, when viewing the mold portion Mo from the face Su to the face Sd, the terminal ts does not protrude from the mold portion Mo in the −X side, and is provided only at a position overlapping with the face Su of the mold portion Mo.

The terminal tg is formed on the −X side relative to the electrode tdm and on the +Y side relative to the electrode tsm on the face Sd of the mold portion Mo. At this time, the terminal tg is formed from the face Sd to the face Sf of the mold portion Mo. Moreover, a region, of the face Sf of the mold portion Mo, where the terminal tg is located has a recessed portion. That is, the terminal tg is located corresponding to the recessed portion formed in the face Sf. As a result, when viewing the switching element M from the +Z side to the −Z side along the Z-axis, that is, when viewing the mold portion Mo from the face Su to the face Sd, the terminal tg does not protrude from the mold portion Mo in the −X side, and is provided only at a position overlapping with the face Su of the mold portion Mo.

As described above, the switching element M used in the drive signal output circuits 51a and 51b of the present embodiment includes the transistor chip Tr, the terminals tg, td, and ts that are electrically coupled to the transistor chip Tr, and the mold portion Mo that covers the transistor chip Tr, and in a direction when viewing the switching element M from the +Z side to the −Z side along the Z-axis, that is, in a direction when viewing the mold portion Mo from the face Su to the face Sd, the terminal tg, the terminal td, and the terminal ts are provided only at positions overlapping with the mold portion Mo.

Next, the structure of the drive signal output circuit 51a including the switching elements M1 and M2, which are the switching element M having the above-described structure, will be described. Here, in the following description, the mold portion Mo included in the switching element M1 may be referred to as a mold portion Mo1, the faces Su, Sd, Sf, Sb, Sl, and Sr included in the mold portion Mo1 may be referred to as faces Su1, Sd1, Sf1, Sb1, Sl1, and Sr1, respectively, the mold portion Mo included in the switching element M2 may be referred to as a mold portion Mo2, and the faces Su, Sd, Sf, Sb, Sl, and Sr included in the mold portion Mo2 may be referred to as faces Su2, Sd2, Sf2, Sb2, S12, and Sr2, respectively.

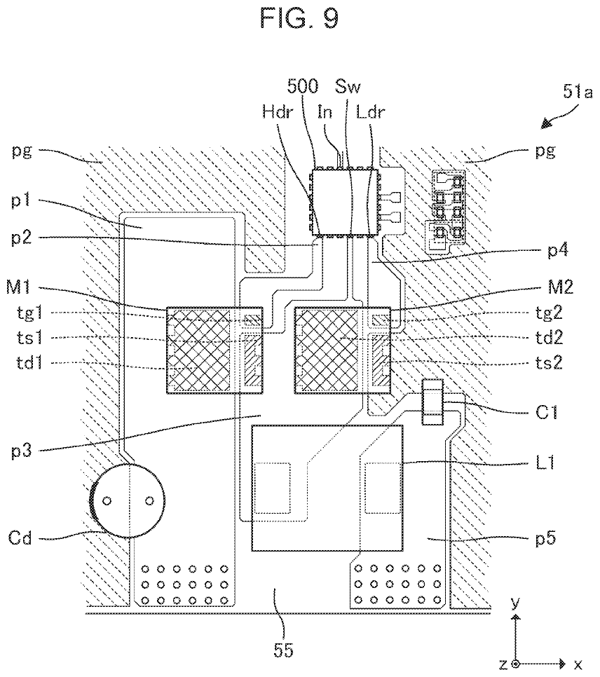

FIG. 9 is a diagram for describing the structure of the drive signal output circuit 51a. Here, in FIG. 9, the description will be made using the x-axis, the y-axis, and the z-axis, which are directions independent of the above-mentioned X-axis, the Y-axis, and the Z-axis, and are orthogonal to each other. In addition, in the following description, when defining a direction along the x-axis, the starting point of the arrow may be referred to as the −x side and the ending point is referred to as the +x side, when defining a direction along the y-axis, the starting point of the arrow may be referred to as the −y side and the ending point is referred to as the +y side, and when defining a direction along the z-axis, the starting point of the arrow may be referred to as the −z side and the ending point is referred to as the +z side. Note that in FIG. 9, illustration of some circuit elements constituting the drive signal output circuit 51a is omitted or simplified.

As shown in FIG. 9, the drive signal output circuit 51a includes the integrated circuit 500, the switching elements M1 and M2, the coil L1, the capacitors C1 and Cd, and a wiring board 55. In the drive signal output circuit 51a, the integrated circuit 500, the switching elements M1 and M2, the coil L1, and the capacitors C1 and Cd are provided on the wiring board 55. Such a wiring board 55 has a wiring pattern for electrically coupling various circuit elements including the integrated circuit 500, the switching elements M1 and M2, the coil L1, and the capacitors C1 and Cd. Note that although FIG. 9 shows a case where the integrated circuit 500, the switching elements M1 and M2, the coil L1, and the capacitors C1, Cd are mounted only the +z side face of the wiring board 55, any of the switching elements M1 and, M2, the coil L1, and the capacitors C1 and Cd may be mounted on the −z side face. Further, the wiring board 55 may be a so-called multilayer board having a plurality of wiring layers between the +z side face and the −z side face.

The switching element M1 and the switching element M2 are located side by side along the x-axis of the wiring board 55 so that the switching element M1 is on the −x side and the switching element M2 is on the +x side.

Specifically, the switching element M1 is provided on the wiring board 55 so that the face Sf1 on which a portion of the terminal tg1 and a portion of the terminal ts1 are provided is located on the +x side, the face Sb1 on which a portion of the terminal td1 is provided is located on the −x side, and the face Sd1 on which the terminals tg1, td1, and ts1 are provided is in contact with the +z side face of the wiring board 55. That is, in the switching element M1, the face Su1 is located on the +z side along the z-axis, the face Sd1 is located on the −z side, and the face Sd1 and the wiring board 55 are in contact with each other. Therefore, in a direction along the direction normal to the wiring board 55, that is, in a direction when viewing the switching element M1 from the +z side to the −z side along the z-axis, the terminal tg1, the terminal td1, and the terminal ts1 are provided only at positions overlapping with the mold portion Mo1. In other words, in a direction along the direction normal to the wiring board 55, that is, in a direction when viewing the switching element M1 along the z-axis from the +z side to the −z side, the terminal tg1, the terminal ts1, and the terminal td1 are provided only at positions overlapping with the face Su1 of the mold portion Mo1, and are not provided at positions that do not overlap with the face Su1 of the mold portion Mo1. That is, in a direction along the direction normal to the wiring board 55, that is, in a direction when viewing the switching element M1 along the z-axis from the +z side to the −z side, the terminal tg1, the terminal ts1, and the terminal td1 do not protrude from the mold portion Mo1 in any of the +X side, −X side, +Y side, and −Y side.

In the switching element M1, the terminal td1 is electrically coupled to a wiring pattern p1 of the wiring board 55, the terminal tg1 is electrically coupled to a wiring pattern p2 of the wiring board 55, and the terminal ts1 is electrically coupled to a wiring pattern p3 of the wiring board 55.

The switching element M2 is provided on the wiring board 55 on the +x side relative to the switching element M1 so that the face Sf2 on which a portion of the terminal tg2 and a portion of the terminal ts2 are provided is located on the +x side, the face Sb2 on which a portion of the terminal td2 is provided is located on the −x side, and the face Sd2 on which the terminals tg2, td2, and ts2 are provided is in contact with the +z side face of the wiring board 55. That is, in the switching element M2, the face Su2 is located on the +z side and the face Sd2 is located on the −z side along the z-axis, and the face Sd2 and the wiring board 55 are in contact with each other. Therefore, in a direction along the direction normal to the wiring board 55, that is, in a direction when viewing the switching element M2 along the z-axis from the +z side to the −z side, the terminals tg2, the terminal td2 and the terminal ts2 are provided only at positions overlapping with the mold portion Mo2. In other words, in a direction along the direction normal to the wiring board 55, that is, in a direction when viewing the switching element M2 along the z-axis from the +z side to the −z side, the terminal tg2, the terminal ts2, and the terminal td2 are provided only at positions overlapping with the face Su2 of the mold portion Mo2, and are not provided at positions that do not overlap with the face Su2 of the mold portion Mo2. That is, in a direction along the direction normal to the wiring board 55, that is, in a direction when viewing the switching element M2 along the z-axis from the +z side to the −z side, the terminal tg2, the terminal ts2, and the terminal td2 do not protrude from the mold portion Mo2 in any of the +X side, −X side, +Y side, and −Y side.

The terminal td2 is electrically coupled to the wiring pattern p3 of the wiring board 55, the terminal tg2 is electrically coupled to a wiring pattern p4 of the wiring board 55, and the terminal ts2 is electrically coupled to a ground wiring pattern pg of the wiring board 55.

The integrated circuit 500 is located on the +y side related to the switching elements M1 and M2 that are disposed side by side along the x-axis. In the integrated circuit 500, the terminal In to which the base drive signal dA is input is located on the +y side of the integrated circuit 500, and the terminal Hdr from which the gate signal Hgd is output to the switching element M1, the terminal Ldr from which the gate signal Lgd is output to the switching element M2, and the terminal Sw electrically coupled to the switching elements M1 and M2 are located on the −y side. The terminal Hdr is electrically coupled to the wiring pattern p2, the terminal Ldr is electrically coupled to the wiring pattern p4, and the terminal Sw is electrically coupled to the wiring pattern p3. Note that in FIG. 9, illustration of the resistor R1 provided between the terminal Hdr and the terminal tg1 of the switching element M1 and the resistor R2 provided between the terminal Ldr and the terminal tg2 of the switching element M2 is omitted. The coil L1 is located on the −y side relative to the switching elements M1 and M2 that are disposed side by side along the x-axis. One end of the coil L1 is electrically coupled to the wiring pattern p3, and the other end of the coil L1 is electrically coupled to a wiring pattern p5.

The capacitor C1 is located on the +X side relative to the switching elements M1 and M2 and the coil L1 all of which are disposed side by side along the x-axis. One end of the capacitor C1 is electrically coupled to the wiring pattern p5, and the other end of the capacitor C1 is electrically coupled to the ground wiring pattern pg.

The capacitor Cd is located on the −X side relative to the coil L1. One end of the capacitor Cd is electrically coupled to the wiring pattern p1, and the other end of the capacitor C1 is electrically coupled to the ground wiring pattern pg.

In the drive signal output circuit 51a configured as described above, the voltage VHV is supplied to the wiring pattern p1. The wiring pattern p1 is electrically coupled to the +side terminal of the capacitor Cd, which is an electrolytic capacitor, and the terminal td1 of the switching element M1. At this time, the capacitor Cd functions as a stabilizing capacitor that reduces the possibility that the voltage value of the voltage VHV will fluctuate.

Further, the terminal tg1 of the switching element M1 is electrically coupled to the terminal Hdr of the integrated circuit 500 via the wiring pattern p2, and the terminal ts1 of the switching element M1 is electrically coupled to the wiring pattern p3. As described above, in the switching element M1 provided on the wiring board 55, whether the terminal td1 and the terminal ts1 are electrically coupled to each other changes according to the gate signal Hgd input via the wiring pattern p2. That is, the switching element M1 switches whether to supply the voltage VHV to the wiring pattern p3 by switching the conduction state between the terminal td1 and the terminal ts1 according to the gate signal Hgd.

The terminal td2 of the switching element M2 is electrically coupled to the wiring pattern p3. Further, the terminal tg2 of the switching element M2 is electrically coupled to the terminal Ldr of the integrated circuit 500 via the wiring pattern p4, and the terminal ts2 of the switching element M2 is electrically coupled to the ground wiring pattern pg to which the ground potential is supplied. As described above, in the switching element M2 provided on the wiring board 55, whether the terminal td2 and the terminal ts2 are electrically coupled to each other changes according to the gate signal Lgd input via the wiring pattern p4. That is, the switching element M2 switches whether to set the electrical potential of the wiring pattern p3 to the ground potential by switching the conduction state between the terminal td2 and the terminal ts2 according to the gate signal Lgd.

As described above, the terminal ts1 of the switching element M1 and the terminal td2 of the switching element M2 are electrically coupled to the wiring pattern p3. As a result, the amplified modulation signal AMs whose voltage value changes between the voltage VHV and the ground potential is output to the wiring pattern p3 according to the gate signals Hgd and Lgd.

Further, one end of the coil L1 is electrically coupled to the wiring pattern p3. The other end of the coil L1 is electrically coupled to the wiring pattern p5. One end of the capacitor C1 is coupled to the wiring pattern p5, and the other end of the capacitor C1 is electrically coupled to the ground wiring pattern pg. As a result, the coil L1 and the capacitor C1 constitute a low pass filter. As a result, the drive signal COMA obtained by demodulating amplified modulation signal AMs is generated in the wiring pattern p5. The drive signal COMA generated in this wiring pattern p5 is output from the drive signal output circuit 51a.

Here, the drive signal output circuit 51b included in the drive circuit 50 together with the drive signal output circuit 51a may be provided on the wiring board 55, or may be provided on a board different from the wiring board 55.

Here, considering that the drive signal COMA is an example of a drive signal, and the drive signal VOUT is generated by selecting or not selecting the signal waveform of the drive signal COMA, the drive signal VOUT is also an example of the drive signal. Furthermore, the control circuit 100 that outputs the base drive signal dA is an example of a base drive signal output circuit. Furthermore, the gate signal Hgd included in the drive signal output circuit 51a is an example of a first control signal, the gate signal Lgd is an example of a second control signal, the switching element M1 is an example of a first switching element, and the switching element M2 is an example of a second switching element. Furthermore, the transistor chip Tr1 included in the switching element M1 is an example of a first transistor chip, the terminal tg1 is an example of a first terminal, the terminal ts1 is an example of a second terminal, the terminal td1 is an example of a third terminal, the mold portion Mo1 is an example of a first mold member, and the reference direction mark Mrk formed on the mold portion Mo1 is an example of a direction indicating mark. Furthermore, the transistor chip Tr2 included in the switching element M2 is an example of a second transistor chip, the terminal tg2 is an example of a fourth terminal, the terminal td2 is an example of a fifth terminal, and the terminal ts2 is an example of a sixth terminal, and the mold portion Mo2 is an example of a second mold member. A direction along the z-axis, that is, a direction from the +z side to the −z side, is an example of a normal direction.

### 6. Functions and Effects

As described above, in the liquid ejection apparatus 1 of the present embodiment, in a direction normal to the wiring board 55, that is, in a direction when viewing the switching element M1 from the +z side to the −z side along the z-axis, the terminal tg1, the terminal td1, and the terminal ts1 are provided only at positions overlapping with the mold portion Mo1. That is, the terminals tg1, ts1, and td1, of the switching element M1, which are various circuits that generate the drive signal COMA from the voltage VHV and are included in the drive signal output circuit 51a through which a large current flows, and whose charging portion is exposed are blocked by the mold portion Mo1. This reduces the possibility that the ink mist adheres to the terminals tg1, ts1, and td1 of the switching element M1. As a result, the signal accuracy of the drive signal COMA output by the drive signal output circuit 51a is improved, and the accuracy of ejection of the ink from the print head 20 including the drive signal output circuit 51a is improved.

Furthermore, in the liquid ejection apparatus 1 of the present embodiment, in a direction normal to the wiring board 55, that is, in a direction when viewing the switching element M2 from the +z side to the −z side along the z-axis, the terminals tg2, the terminal td2 and the terminal ts2 are provided only at positions overlapping with the mold portion Mo2. That is, the terminals tg2, ts2, and td2 of the switching element M2, which is are various circuits that generate the drive signal COMA from the voltage VHV included in the drive signal output circuit 51a through which a large current flows, and whose charging portion is exposed are blocked by the mold portion Mo2. This reduces the possibility that the ink mist adheres to the terminals tg2, ts2, and td2 of the switching element M2. As a result, the signal accuracy of the drive signal COMA output by the drive signal output circuit 51a is further improved, and the accuracy of ejection of the ink from the print head 20 including the drive signal output circuit 51a is further improved.

Although the embodiments and the modification have been described above, the present disclosure is not limited to the embodiments and the modifications, and can be implemented in various modes without departing from the gist of the disclosure. For example, it is also possible to combine the above embodiments as appropriate.

The disclosure includes a configuration substantially same as the configuration described in the embodiments (for example, a configuration having the same function, method, and result, or a configuration having the same object and effect). Further, the disclosure includes a configuration in which a non-essential part of the configuration described in the embodiments is replaced. Further, the disclosure includes a configuration having the same functions and effects as the configuration described in the embodiments or a configuration capable of achieving the same object. The disclosure also includes a configuration in which a known technique is added to the configuration described in the embodiments.

The following content is derived from the embodiments described above.

An aspect of a liquid ejection apparatus includes an ejection head that ejects a liquid according to driving of a piezoelectric element, a drive signal output circuit that outputs a drive signal for driving the piezoelectric element, and a base drive signal output circuit that outputs a base drive signal that is a base of the drive signal, wherein the drive signal output circuit includes an integrated circuit that receives the base drive signal and outputs a first control signal, a first switching element operated by the first control signal, and a wiring board on which the integrated circuit and the first switching element are provided, wherein the first switching element includes a first transistor chip, a first terminal, a second terminal, and a third terminal all of which are electrically coupled to the first transistor chip, and a first mold member covering the first transistor chip, wherein a conduction state between the second terminal and the third terminal is controlled according to the first control signal input to the first terminal, and wherein the first terminal, the second terminal, and the third terminal are provided only at positions overlapping with the first mold member along a direction normal to the wiring board.

According to the liquid ejection apparatus, the first terminal, the second terminal, and the third terminal of the first switching element are provided only at positions overlapping with the first mold member along the direction normal to the wiring board, so that the possibility that the liquid mist adheres to the first terminal, the second terminal, and the third terminal of the first switching element is reduced. As a result, the waveform accuracy of the drive signal output by the drive signal output circuit is improved, and the accuracy of ejection of the ink from the ejection head is improved.

In an aspect of the liquid ejection apparatus, the first mold member may include a direction indicating mark indicating a direction of the first switching element.

According to the liquid ejection apparatus, even when the first terminal, the second terminal, and the third terminal of the first switching element are provided at positions overlapping with the first mold member, it is possible to check the mounting direction of the first switching element.

In an aspect of the liquid ejection apparatus, the first mold member may be made of an epoxy resin containing glycidyl group-containing polybutadiene.

According to the liquid ejection apparatus, even when the solvent ink or the like including an organic solvent as a medium is used, the possibility that an abnormality will occur in the first switching element is reduced.

In an aspect of the liquid ejection apparatus, the drive signal output circuit may supply the drive signal to the 5000 or more piezoelectric elements.

According to the liquid ejection apparatus, the possibility that the liquid mist adheres to the first terminal, the second terminal, and the third terminal of the first switching element is reduced. Therefore, even when a large current is generated due to the propagation of the drive signal because the drive signal output circuit supplies the drive signal to 5000 or more piezoelectric elements, the possibility that the waveform accuracy of the drive signal output by the drive signal output circuit decreases is reduced, and the possibility that the accuracy of ejection of the ink from the ejection head decreases is reduced.

In an aspect of the liquid ejection apparatus, the integrated circuit may output a second control signal, wherein the drive signal output circuit may include a second switching element provided on the wiring board and operated by the second control signal, wherein the second switching element may include a second transistor chip, a fourth terminal, a fifth terminal, and a sixth terminal all of which are electrically coupled to the second transistor chip, and a second mold member covering the second transistor chip, wherein a conduction state between the fifth terminal and the sixth terminal may be controlled according to the second control signal input to the fourth terminal, and wherein the fourth terminal, the fifth terminal, and the sixth terminal may be provided only at positions overlapping with the second mold member along the direction normal to the wiring board.

According to the liquid ejection apparatus, the fourth terminal, the fifth terminal, and the sixth terminal of the second switching element are provided only at positions overlapping with the second mold member along the direction normal to the wiring board, so that the possibility that the liquid mist adheres to the fourth terminal, the fifth terminal, and the sixth terminal of the second switching element is reduced. As a result, the waveform accuracy of the drive signal output by the drive signal output circuit is further improved, and the accuracy of ejection of the ink from the ejection head is further improved.

In an aspect of the liquid ejection apparatus, the drive signal output circuit may include a demodulation circuit, wherein the integrated circuit may output the first control signal and the second control signal according to a modulation signal obtained by modulating the base drive signal, wherein the second terminal and the fifth terminal may be electrically coupled to each other, and wherein the demodulation circuit may demodulate a signal at a coupling point where the second terminal and the fifth terminal are electrically coupled to output the demodulated signal as the drive signal.

According to the liquid ejection apparatus, the drive signal output circuit amplifies the base drive signal to output the drive signal by switching operations of the first switching element and the second switching element. That is, the drive signal output circuit performs class D amplification on the base drive signal to output the drive signal. As a result, the amplification efficiency in the drive signal output circuit can be increased, and even when a drive signal accompanied by a large current is output, it is possible to reduce the possibility that the power consumption of the drive signal output circuit increases.

An aspect of a print head includes an ejection head that ejects a liquid according to driving of a piezoelectric element, and a drive signal output circuit that outputs a drive signal for driving the piezoelectric element, wherein the drive signal output circuit includes an integrated circuit that receives a base drive signal that is a base of the drive signal and outputs a first control signal, a first switching element operated by the first control signal, and a wiring board on which the integrated circuit and the first switching element are provided, wherein the first switching element includes a first transistor chip, a first terminal, a second terminal, and a third terminal all of which are electrically coupled to the first transistor chip, and a first mold member covering the first transistor chip, wherein a conduction state between the second terminal and the third terminal is controlled according to the first control signal input to the first terminal, and wherein the first terminal, the second terminal, and the third terminal are provided only at positions overlapping with the first mold member along a direction normal to the wiring board.

According to the print head, the first terminal, the second terminal, and the third terminal of the first switching element are provided only at positions overlapping with the first mold member along the direction normal to the wiring board, so that the possibility that the liquid mist adheres to the first terminal, the second terminal, and the third terminal of the first switching element is reduced. As a result, the waveform accuracy of the drive signal output by the drive signal output circuit is improved, and the accuracy of ejection of the ink from the ejection head is improved.

In an aspect of the print head, the first mold member may include a direction indicating mark indicating a direction of the first switching element.

According to the print head, even when the first terminal, the second terminal, and the third terminal of the first switching element are provided at positions overlapping with the first mold member, it is possible to check the mounting direction of the first switching element.

In an aspect of the print head, the first mold member is made of an epoxy resin containing glycidyl group-containing polybutadiene.

According to the print head, even when the solvent ink or the like including an organic solvent as a medium is used, the possibility that an abnormality will occur in the first switching element is reduced.

In an aspect of the print head, the drive signal output circuit may supply the drive signal to the 5000 or more piezoelectric elements.

According to the print head, the possibility that the liquid mist adheres to the first terminal, the second terminal, and the third terminal of the first switching element is reduced. Even when a large current is generated due to the propagation of the drive signal because the drive signal output circuit supplies the drive signal to 5000 or more piezoelectric elements, the possibility that the waveform accuracy of the drive signal output by the drive signal output circuit decreases is reduced, and the possibility that the accuracy of ejection of the ink from the ejection head decreases is reduced.

In an aspect of the print head, the integrated circuit may output a second control signal, wherein the drive signal output circuit may include a second switching element provided on the wiring board and operated by the second control signal, wherein the second switching element may include a second transistor chip, a fourth terminal, a fifth terminal, and a sixth terminal all of which are electrically coupled to the second transistor chip, and a second mold member covering the second transistor chip, wherein a conduction state between the fifth terminal and the sixth terminal may be controlled according to the second control signal input to the fourth terminal, and wherein the fourth terminal, the fifth terminal, and the sixth terminal may be provided only at positions overlapping with the second mold member along the direction normal to the wiring board.

According to the print head, the fourth terminal, the fifth terminal, and the sixth terminal of the second switching element are provided only at positions overlapping with the second mold member along the direction normal to the wiring board, so that the possibility that the liquid mist adheres to the fourth terminal, the fifth terminal, and the sixth terminal of the second switching element is reduced. As a result, the waveform accuracy of the drive signal output by the drive signal output circuit is further improved, and the accuracy of ejection of the ink from the ejection head is further improved.

In an aspect of the print head, the drive signal output circuit may include a demodulation circuit, wherein the integrated circuit may output the first control signal and the second control signal according to a modulation signal obtained by modulating the base drive signal, wherein the second terminal and the fifth terminal may be electrically coupled to each other, and wherein the demodulation circuit may demodulate a signal at a coupling point where the second terminal and the fifth terminal are electrically coupled to output the demodulated signal as the drive signal.

According to the print head, the drive signal output circuit amplifies the base drive signal to output the drive signal by switching operations of the first switching element and the second switching element. That is, the drive signal output circuit performs class D amplification on the base drive signal to output the drive signal. As a result, the amplification efficiency in the drive signal output circuit can be increased, and even when a drive signal accompanied by a large current is output, it is possible to reduce the possibility that the power consumption of the drive signal output circuit increases.

What is claimed is:

1. A liquid ejection apparatus comprising:
an ejection head that ejects a liquid according to driving of a piezoelectric element;
a drive signal output circuit that outputs a drive signal for driving the piezoelectric element; and
a base drive signal output circuit that outputs a base drive signal that is a base of the drive signal, wherein
the drive signal output circuit includes
an integrated circuit that receives the base drive signal and outputs a first control signal,
a first switching element operated by the first control signal, and
a wiring board on which the integrated circuit and the first switching element are provided, wherein
the first switching element includes
a first transistor chip,
a first terminal, a second terminal, and a third terminal all of which are electrically coupled to the first transistor chip, and
a first mold member covering the first transistor chip, wherein
a conduction state between the second terminal and the third terminal is controlled according to the first control signal input to the first terminal, and wherein
the first terminal, the second terminal, and the third terminal are provided only at positions overlapping with the first mold member along a direction normal to the wiring board.

2. The liquid ejection apparatus according to claim 1, wherein
the first mold member includes a direction indicating mark indicating a direction of the first switching element.

3. The liquid ejection apparatus according to claim 1, wherein
the first mold member is made of an epoxy resin containing glycidyl group-containing polybutadiene.

4. The liquid ejection apparatus according to claim 1, wherein
the drive signal output circuit supplies the drive signal to the 5000 or more piezoelectric elements.

5. The liquid ejection apparatus according to claim 1, wherein
the integrated circuit outputs a second control signal, wherein
the drive signal output circuit includes a second switching element provided on the wiring board and operated by the second control signal, wherein
the second switching element includes
a second transistor chip,
a fourth terminal, a fifth terminal, and a sixth terminal all of which are electrically coupled to the second transistor chip, and
a second mold member covering the second transistor chip, wherein
a conduction state between the fifth terminal and the sixth terminal is controlled according to the second control signal input to the fourth terminal, and wherein
the fourth terminal, the fifth terminal, and the sixth terminal are provided only at positions overlapping with the second mold member along the direction normal to the wiring board.

6. The liquid ejection apparatus according to claim 5, wherein
the drive signal output circuit includes a demodulation circuit, wherein
the integrated circuit outputs the first control signal and the second control signal according to a modulation signal obtained by modulating the base drive signal, wherein
the second terminal and the fifth terminal are electrically coupled to each other, and wherein
the demodulation circuit demodulates a signal at a coupling point where the second terminal and the fifth terminal are electrically coupled to output the demodulated signal as the drive signal.

7. A print head comprising:
an ejection head that ejects a liquid according to driving of a piezoelectric element; and
a drive signal output circuit that outputs a drive signal for driving the piezoelectric element, wherein
the drive signal output circuit includes
an integrated circuit that receives a base drive signal that is a base of the drive signal and outputs a first control signal,
a first switching element operated by the first control signal, and
a wiring board on which the integrated circuit and the first switching element are provided, wherein
the first switching element includes
a first transistor chip,
a first terminal, a second terminal, and a third terminal all of which are electrically coupled to the first transistor chip, and
a first mold member covering the first transistor chip, wherein
a conduction state between the second terminal and the third terminal is controlled according to the first control signal input to the first terminal, and wherein
the first terminal, the second terminal, and the third terminal are provided only at positions overlapping with the first mold member along a direction normal to the wiring board.

8. The print head according to claim 7, wherein
the first mold member includes a direction indicating mark indicating a direction of the first switching element.

9. The print head according to claim 7, wherein
the first mold member is made of an epoxy resin containing glycidyl group-containing polybutadiene.

10. The print head according to claim 7, wherein
the drive signal output circuit supplies the drive signal to the 5000 or more piezoelectric elements.

11. The print head according to claim 7, wherein
the integrated circuit outputs a second control signal, wherein
the drive signal output circuit includes a second switching element provided on the wiring board and operated by the second control signal, wherein
the second switching element includes
a second transistor chip,
a fourth terminal, a fifth terminal, and a sixth terminal all of which are electrically coupled to the second transistor chip, and
a second mold member covering the second transistor chip, wherein
a conduction state between the fifth terminal and the sixth terminal is controlled according to the second control signal input to the fourth terminal, and wherein
the fourth terminal, the fifth terminal, and the sixth terminal are provided only at positions overlapping with the second mold member along the direction normal to the wiring board.

12. The print head according to claim 11, wherein
the drive signal output circuit includes a demodulation circuit, wherein
the integrated circuit outputs the first control signal and the second control signal according to a modulation signal obtained by modulating the base drive signal, wherein
the second terminal and the fifth terminal are electrically coupled to each other, and wherein
the demodulation circuit demodulates a signal at a coupling point where the second terminal and the fifth terminal are electrically coupled to output the demodulated signal as the drive signal.
